(19) United States
(12) Patent Application Publication
(10) Pub. No.: US 2004/0193697 A1
(43) Pub. Date: Sep. 30, 2004

(54) Accessing a remotely-stored data set and associating notes with that data set

(76) Inventors: David Arthur Grosvenor, South Gloucestershire Bristol (GB); David Mark Frohlich, Westbury-on-Trym Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/476,450

(22) PCT Filed: Jan. 9, 2003
(86) PCT No.: PCT/GB03/00101

(30) Foreign Application Priority Data
Jan. 10, 2002 (GB) 0200478.6

(51) Int. Cl. G06F 15/16

(52) U.S. Cl. 709/217

(57) ABSTRACT

A method of associating hand written notes with a stored data set, comprising using a data processor to access the data set, making meaningful hand-written notes, reading and storing images of those notes linked to a record of the state of the data processor when accessing the data set; repeating the process for multiple data sets; then retrieving and reproducing some or all of the associated notes linked with any data set currently being accessed by the data processor, by addressing the record with the current state of the data processor.

### CROSS REFERENCE TO RELATED APPLICATIONS

Not Applicable

### STATEMENT REGARDING FEDERALLY SPONSORED RESEARCH OR DEVELOPMENT

Not Applicable

### INCORPORATION BY REFERENCE OF MATERIAL SUBMITTED ON A COMPACT DISC

Not Applicable

### BACKGROUND OF INVENTION

1. Technical Field Invention

This invention relates to a method, a system and a program for accessing a remotely stored data set such as a web page on the Internet, using an associated note as an index to it. It also relates to a method, system and program for retrieving and reproducing notes associated with such a remotely stored data set.

2. Background Art

The world-wide web is a complex data set representing material capable of being perceived by the senses, such as textual, pictorial, audio and video material. Web browsing has many practical limitations not present with books, photograph albums or record libraries, for example, in that it is awkward to make contemporaneous notes about the content of the pages being browsed, and it is not possible to use a physical note to index into a set of previously browsed web pages.

Browsing the world-wide web and taking notes about the content of web pages is already supported in a number of ways, both in the pure electronic world and by means of a combination of physical and electronic worlds.

In the pure electronic world, it is well known to record web page addresses in the form of a list of favourites or bookmarks. These lists can be structured in folders, and a folder may be used to hold a particular ad-hoc query, such as the search for a holiday. This approach does not allow for the recording of notes, and the ad-hoc query is a semi-permanent change to the web browser's bookmarks that will need to be managed. Bookmarks are not well suited to such temporary queries and are often congested already.

A web page editor, such as the Microsoft Front-Page, can be used to take notes and the address of the web page can be recorded with a hyper-link to the document currently viewed. This however competes for the limited screen space with the web browser and so forces the user to manage the screen space.

These electronic world solutions all compete for the limited screen space, and any note taking is less natural than using pen and paper.

In the combination of physical and electronic worlds, the pen and paper may be used for note taking. The web page address may be recorded manually simply by writing down the URL. To retrieve the web page the address is then typed in directly. This is prone to error both in recordal and subsequent retrieval, and it requires several steps to be taken by the user.

Instead of typing the web page address in order to retrieve the web page, it would be theoretically possible to scan the web page address from the page, but this system would still be vulnerable to errors recording the web page address on the paper in the first place, and the means for capturing the handwriting can be awkward.

In a variation of this, pen and paper are used for note taking, but when a web page address is required a label is printed and placed on the paper. This avoids the errors in recording the web address. However, if the user is to type it again the label might need to be quite large for easy handling, and it would have to be fairly large to be read by optical character recognition (OCR). Retrieval could however be automated more easily by making such a label machine readable, through a barcode or magnetic code, but again an input device would be needed.

The Xerox Corporation has a number of publications for the storage and retrieval of information correlated with a recording of an event. U.S. Pat. No. 5,535,063 (Lamming) discloses the use of electronic scribing on a note pad or other graphical input device, to create an electronic note which is then time stamped and thereby associated temporally with the corresponding event in a sequence of events. The system is said to be particularly useful in audio and video applications; the graphical input device can also be used to control the operation of playback of audio or video retrieved using the note. In U.S. Pat. No. 5,564,005, substantially more detail is given of systems for providing flexible note taking which complements diverse personal note taking styles and application needs. It discloses versatile data structures for organising the notes entered by the system user, to facilitate data access and retrieval to both concurrently or previously-recorded signals.

They are restricted to time based indexing, and do not provide a means of indexing into an arbitrary data set.

Also of some relevance is WO00/70585 which discloses the MediaBridge system of Digimarc Corporation for encoding print to link an object to stored data associated with that object. For example, paper products are printed with visually readable text and also with a digital watermark, which is read by a processor and used to index a record of web addresses to download a corresponding web page for display. The client application of the MediaBridge system is used in homes and businesses by consumers automatically to navigate from an image or object to additional information, usually on the Internet. An embedding system is used by the media owners to embed the MediaBridge codes into images prior to printing. A handheld scanner such as the Hewlett Packard CapShare 920 scanner may be configured for use with any type of identifier such as a watermark, barcode or mark readable by optical character recognition (OCR) software.

However, this system requires the indexing information to be printed on the relevant medium and cannot be edited or updated or entered manually.

WO00/56055 also provides background information to the invention. An internet web server has a separate notes server and database for building up a useful set of notes, such as images, text documents or documents expressed in a page description language such as postscript or Adobe PDF, contributed by different users' web browsers over the internet asynchronously, the notes relating to the content of respective documents. These notes can be accessed or edited by the same or different users with appropriate privileges by identifying the URL of the annotated document.

The purpose of the present invention is to overcome or at least mitigate the disadvantages of previous systems such as those described above.

### SUMMARY OF INVENTION

A first aspect of the invention concerns a method of accessing a stored data set using a data processor whose state determines which data set of many is accessed, comprising manually entering a note on a page using a graphical input device, the note relating to the content of the data set currently accessed by the data processor, identifying and storing the location of the note in a logical spatial map for the page, repeating the manual entry and storage steps to build up a plurality of such notes linked to the corresponding states of the processor, and then retrieving a required data set by manually selecting the corresponding page in the graphical input device and gesturing on the page to identify in the spatial map the corresponding previously-entered note, using this to reset the data processor to its corresponding state and accessing thereby the corresponding data set linked to the note. Preferably, the graphical input device comprises notepaper and a writing and/or pointing implement and a camera focused on the note paper to read its content.

Preferably, the manual entry of the note comprises reading the page of note paper and identifying whether any note on it has previously been recorded electronically, recording that note electronically if it has not previously been recorded electronically, and updating a logical spatial map for that page with the note entered.

Preferably, in this case, the retrieval comprises presenting a page to the camera and reading and identifying a specific note on the page using a manual gesture on the note paper viewed and read by the camera.

Whilst the data sets can be linked temporally, by a time-indexing system such as video which links different video clips by a tape medium on which they are stored, this is not essential—the data sets may be linked only by the sequence in which they are accessed, e.g. in the case of web pages being accessed.

A second aspect of the invention concerns a method of associating hand written notes with a stored data set, comprising using a data processor to access the data set, making meaningful hand-written notes, reading and storing images of those notes linked to a record of the state of the data processor when accessing the data set; repeating the process for multiple data sets; then retrieving and reproducing some or all of the associated notes linked with any data set currently being accessed by the data processor, by addressing the record with the current state of the data processor.

Preferably, the reproduction of the notes is in the form of an image displayed on a screen which also displays the data set.

Conveniently, the reproduction of the notes is in the form of a printed image.

In the case of the first and second aspects of the invention, the data set may be remotely stored and may be on a web page on the world-wide web, and the data processor may comprise a web browser.

Alternatively, the data set may be stored in an on-line data repository or bulletin board accessible by a navigation device or other appropriate program in the data processor.

The first aspect of the invention also comprises a computer system for accessing a stored data set, comprising a data processor whose state determines which data set of many is accessed, connected to a graphical input device for the manual entry of a note on a page, the note relating to the content of the data set currently accessed by the data processor, and processing means for identifying and storing the location of the note in a logical spatial map for the page, repeating the manual entry and storage steps to build up a plurality of such notes linked to the corresponding states of the processor, and then retrieving a required data set by manually selecting the corresponding page in the graphical input device and gesturing on the page to identify in the spatial map the corresponding previously-entered note, using this to reset the data processor to its corresponding state and accessing thereby the corresponding data set linked to the note.

The first aspect of the invention also concerns a computer program for use in a system for accessing a stored data set, the program having the steps of controlling a graphical input device to read a note entered manually on a page, the note relating to the content of the data set currently accessed by the data processor, identifying and storing the location of the note in a logical spatial map for the page, repeating the manual entry and storage steps to build up a plurality of such notes linked to the corresponding states of the processor, and then retrieving the required data set by controlling the graphical input device to read a manually selected corresponding page and to read gestures made manually on the page to identify in the spatial map the corresponding previously-entered note, using this to reset the data processor to its corresponding state and accessing thereby the corresponding data set linked to the note.

The second aspect of the invention also comprises a computer system for associating hand-written notes with a stored data set, comprising a data processor for accessing the data set, means for reading and storing images of hand-written notes relevant to the data set, linked to a record of the state of the data processor when accessing the data set; and for then retrieving and reproducing some or all of the associated notes linked with any data set currently being accessed by the data processor, by addressing the record with the current state of the data processor.

The second aspect of the invention further comprises a computer program for use in a system for associating hand-written notes with a stored data set, the system having a data processor for accessing the data set, the program having the steps of reading and storing images of hand-written notes relevant to the data set, linked to a record of the state of the data processor when accessing the data set; repeating the process for multiple data sets; and then retrieving and reproducing some or all of the associated notes linked with any data set currently being accessed by the data processor, by addressing the record with the current state of the data processor.

The invention may be adapted to the use of a users speech input, optionally with conventional speech recognition, in place of the graphic interface and graphic notes—thus audio recordings may replace the graphic notes.

Accordingly, a third aspect of the invention relates to a method of accessing a stored data set using a data processor whose state determines which data set of many is accessed, comprising storing at least one audio speech recording relating to the content of the data set currently accessed by the data processor, repeating the step of storing audio speech recordings whilst accessing different data sets, each recording relating to the content of its respective data set, to build up a plurality of such recordings linked to the corresponding states of the processor, and then retrieving a required data set by speaking at least part of one of the audio speech recordings, recognising the audio speech recording from what was spoken, identifying from that recording the corresponding state of the data processor and using this to reset the data processor to its corresponding state and accessing thereby the corresponding data set linked to the recording.

Further, a fourth aspect of the invention relates to a method of associating audio speech recordings with a stored data set, comprising using a data processor to access the data set, making meaningful audio speech recordings linked to a record of the state of the data processor when accessing the data set; repeating the process for multiple data sets; then retrieving and reproducing some or all of the associated audio speech recordings linked with any data set currently being accessed by the data processor, by addressing the record with the current state of the data processor.

The third aspect of the invention also relates to a computer system for accessing a stored data set, comprising a data processor whose state determines which data set of many is accessed, connected to an audio input device for the recording of speech relating to the content of the data set currently accessed by the data processor, a processing arrangement for storing such audio speech recordings linked to the corresponding states of the processor, the processing arrangement including a speech recognition segment responsive to at least part of the content of one of the audio speech recordings being spoken into the audio input device to identify that recording, the processing arrangement thus being responsive to speech input to identify the corresponding state of the data processor and to reset the data processor to its corresponding state to access thereby the corresponding data set linked to the audio speech recording.

The third aspect of the invention also relates to a memory storing a computer program for use in a system for accessing a stored data set, the program having the steps of controlling an audio input device to record an audio speech recording relating to the content of the data set currently accessed by the data processor, repeating the step of storing audio speech recordings whilst accessing different data sets, each recording relating to the content of its respective data set, to build up a plurality of such recordings linked to the corresponding states of the processor, and then retrieving a required data set by speaking at least part of one of the audio speech recordings, recognising the audio speech recording from what was spoken, identifying from that recording the corresponding state of the data processor and using this to reset the data processor to its corresponding state and accessing thereby the corresponding data set linked to the recording.

The fourth aspect of the invention also relates to a computer system for associating audio speech recordings with a stored data set, comprising a data processor for accessing the data set, means for inputting and recording audio speech relevant to the content of the data set, linked to a record of the state of the data processor when accessing the data set; and for then retrieving and reproducing some or all of the associated audio speech recordings linked with any data set currently being accessed by the data processor, by addressing the record with the current state of the data processor.

The fourth aspect of the invention also concerns a memory storing a computer program for use in a system for associating audio speech recordings with a stored data set, the system having a data processor for accessing the data set, the program having the steps of inputting and recording audio speech relevant to the data set, linked to a record of the state of the data processor when accessing the data set; repeating the process for multiple data sets; and then retrieving and reproducing some or all of the associated audio speech recordings linked with any data set currently being accessed by the data processor, by addressing the record with the current state of the data processor.

More generally, any recorded annotations or commentary, whether graphic or audio or pertaining to another sense, may be used and linked with the state of the data processor and thus the data set.

Accordingly, a fifth aspect of the invention relates to a method of accessing a stored data set using a data processor whose state determines which data set of many is accessed, the method comprising storing at least one recording relating to the content of the data set currently accessed by the data processor, repeating the step of storing recordings whilst accessing different data sets, each recording relating to the content of its respective data set, to build up a plurality of such recordings linked to the corresponding states of the processor, and then retrieving a required data set by repeating at least part of one of the recordings, recognising the recording from what was repeated, identifying from that recording the corresponding state of the data processor and using this to reset the data processor to its corresponding state and accessing thereby the corresponding data set linked to the recording.

A sixth aspect of the invention concerns a method of associating recordings with a stored data set, the method comprising using a data processor to access the data set, making meaningful recordings linked to a record of the state of the data processor when accessing the data set; repeating the process for multiple data sets; then retrieving and reproducing some or all of the associated recordings linked with any data set currently being accessed by the data processor, by addressing the record with the current state of the data processor.

### BRIEF DESCRIPTION OF THE DRAWINGS

In order that the invention may be better understood, preferred embodiments will now be described, by way of example only, with reference to the accompanying drawings, in which:

FIG. 1 is a simple system architecture diagram of a graphical input device.

FIG. 2 is a plan view of a printed paper document with calibration marks and a page identification mark;

FIG. 3 is a close up plan view of one of the calibration marks;

FIG. 4 is a close up plan view of the page identification mark comprising a two dimensional barcode;

FIG. 5 is a flowchart demonstrating the operation of the system for reading from the graphical input device of FIGS. 1 to 4;

FIG. 6 is a flowchart illustrating the process, embodying the present invention, for reading existing notes and creating new notes;

FIG. 7 is a flow diagram illustrating the routine labelled “update note record” of FIG. 6; and

FIG. 8 is a flow chart illustrating a routine labelled “note look up” of FIG. 6.

### DETAILED DESCRIPTION OF THE DRAWING

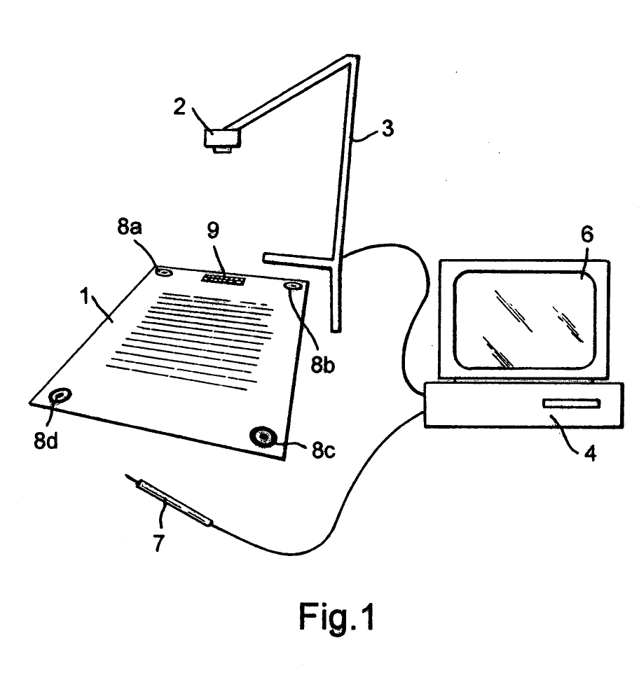

Referring firstly to FIG. 1, this illustrates a graphical input device for notepaper, as set up for operation. The system/apparatus comprises, in combination, a printed or scribed document 1, in this case a sheet of paper that is suitably, for example, a printed page from a holiday brochure; a camera 2, that is suitably a digital camera and particularly suitably a digital video camera, which is held above the document 1 by a stand 3 and focuses down on the document 1; a processor/computer 4 to which the camera 2 is linked, the computer suitably being a conventional PC having an associated VDU/monitor 6; and a pointer 7 with a pressure sensitive tip and which is linked to the computer 4.

The document 1 differs from a conventional printed brochure page in that it bears a set of four calibration marks 8a-8d, one mark 8a-d proximate each corner of the page, in addition to a two-dimensional bar code which serves as a readily machine-readable page identifier mark 9 and which is located at the top of the document 1 substantially centrally between the top edge pair of calibration marks 8a, 8b.

The calibration marks 8a- 8d are position reference marks that are designed to be easily differentiable and localisable by the processor of the computer 4 in the electronic images of the document 1 captured by the overhead camera 2.

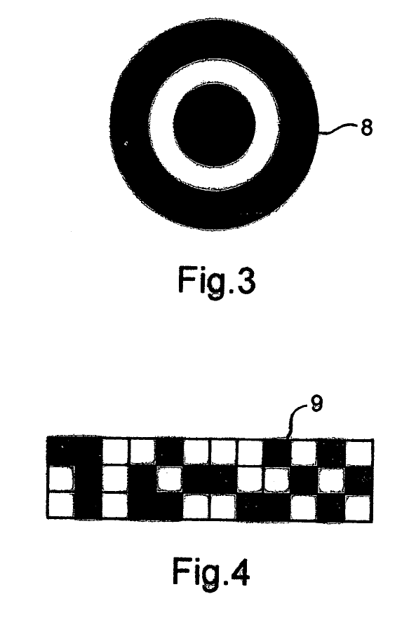

The illustrated calibration marks 8a- 8d are simple and robust, each comprising a black circle on a white background with an additional black circle around it as shown in FIG. 3. This gives three image regions that share a common centre (central black disc with outer white and black rings). This relationship is approximately preserved under moderate perspective projection as is the case when the target is viewed obliquely.

It is easy to robustly locate such a mark 8 in the image taken from the camera 2. The black and white regions are made explicit by thresholding the image using either a global or preferably a locally adaptive thresholding technique. Examples of such techniques are described in:

Gonzalez R. C & Woods R. E. R. “Digital Image Processing”, Addison-Wesley, 1992, pages 443-455; and Rosenfeld A. & Kak A. Digital Picture Processing (second edition), Volume 2, Academic Press, 1982, pages 61-73.

After thresholding, the pixels that make up each connected black or white region in the image are made explicit using a component labelling technique. Methods for performing connected component labelling/analysis both recursively and serially on a raster by raster basis are described in: Jain R., Kasturi R. & Schunk B. Machine Vision, McGraw-Hill, 1995, pages 42-47 and Rosenfeld A. & Kak A. Digital Picture Processing (second edition), Volume 2, Academic Press, 1982, pages 240-250.

Such methods explicitly replace each component pixel with a unique label.

Black components and white components can be found through separate applications of a simple component labelling technique. Alternatively it is possible to identify both black and white components independently in a single pass through the image. It is also possible to identify components implicitly as they evolve on a raster by raster basis keeping only statistics associated with the pixels of the individual connected components (this requires extra storage to manage the labelling of each component).

In either case what is finally required is the centre of gravity of the pixels that make up each component and statistics on its horizontal and vertical extent. Components that are either too large or too small can be eliminated straight off. Of the remainder what we require are those which approximately share the same centre of gravity and for which the ratio of their horizontal and vertical dimensions agrees roughly with those in the calibration mark 8. An appropriate black, white, black combination of components identifies a calibration mark 8 in the image. Their combined centre of gravity (weighted by the number of pixels in each component) gives the final location of the calibration mark 8.

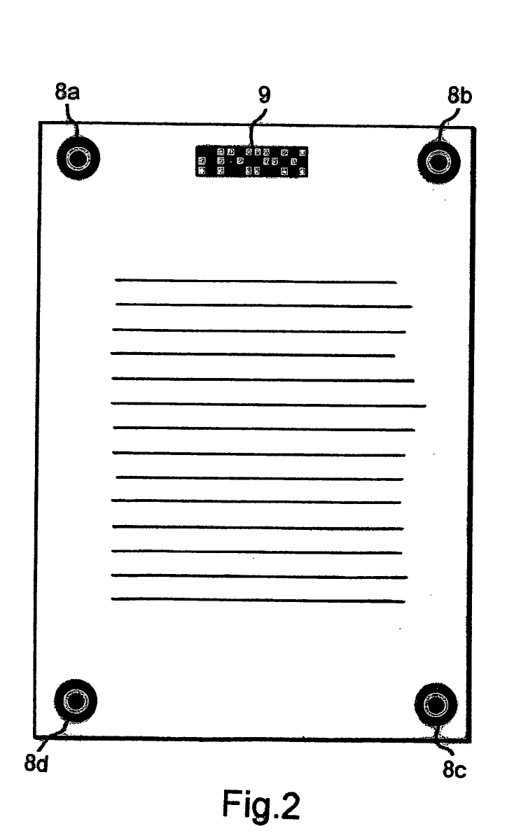

The minimum physical size of the calibration mark 8 depends upon the resolution of the sensor/camera 2. Typically the whole calibration mark 8 must be more than about 60 pixels in diameter. For a 3MP camera imaging an A4 document there are about 180 pixels to the inch so a 60 pixel target would cover ⅓^{rd} of an inch. It is particularly convenient to arrange four such calibration marks 8a-d at the corners of the page to form a rectangle as shown in the illustrated embodiment FIG. 2.

For the simple case of fronto-parallel (perpendicular) viewing it is only necessary to correctly identify two calibration marks 8 in order to determine the location, orientation and scale of the documents. Furthermore for a camera 2 with a fixed viewing distance the scale of the document 1 is also fixed (in practice the thickness of the document, or pile of documents, affects the viewing distance and, therefore, the scale of the document).

In the general case the position of two known calibration marks 8 in the image is used to compute a transformation from image co-ordinates to those of the document 1 (e.g. origin at the top left hand corner with the x and y axes aligned with the short and long sides of the document respectively). The transformation is of the form:

$$[ \begin{matrix}{X}^{′} \\ {Y}^{′} \\ 1\end{matrix} ] = [ \begin{matrix}k cos θ & - sin θ & {t}_{x} \\ sin θ & k cos θ & {t}_{y} \\ 0 & 0 & 1\end{matrix} ] [ \begin{matrix}X \\ Y \\ 1\end{matrix} ]$$

where (X, Y) is a point in the image and (X′, Y′) is the corresponding location on the document (1) with respect to the document page co-ordinate system. For these simple 2D displacements the transform has three components: an angle θ, a translation (tₓ, t_{y}) and a overall scale factor k. These can be computed from two matched points and the imaginary line between them using standard techniques (see for example: HYPER: A New Approach for the Recognition and Positioning of Two-Dimensional Objects, IEEE Trans. Pattern Analysis and Machine Intelligence, Volume 8, No. 1, January 1986, pages 44-54).

With just two identical calibration marks 8a, 8b it may be difficult to determine whether they lie on the left or right of the document or the top and bottom of a rotated document 1 (or in fact at opposite diagonal corners). One solution is to use non-identical marks 8, for example, with different numbers of rings and/or opposite polarities (black and white ring order). This way any two marks 8 can be identified uniquely.

Alternatively a third mark 8 can be used to resolve ambiguity. Three marks 8 must form an L-shape with the aspect ratio of the document 1. Only a 180 degree ambiguity then exists for which the document 1 would be inverted for the user and thus highly unlikely to arise.

Where the viewing direction is oblique (allowing the document 1 surface to be non-fronto-parallel or extra design freedom in the camera 2 rig) it is necessary to identify all four marks 8a-8d in order to compute a transformation between the viewed image co-ordinates and the document 1 page co-ordinates.

The perspective projection of the planar document 1 page into the image undergoes the following transformation:

$$[ \begin{matrix}x \\ y \\ w\end{matrix} ] = [ \begin{matrix}a & b & c \\ b & e & f \\ g & h & 1\end{matrix} ] [ \begin{matrix}X \\ Y \\ 1\end{matrix} ]$$

where X′=x/w and Y′=y/w.

Once the transformation has been computed then it can be used to locate the document page identifier bar code 9 from the expected co-ordinates for its location that are held in a register in the computer 4. Also the computed transformation can be used to map events (e.g. pointing) in the image to events on the page (in its electronic form).

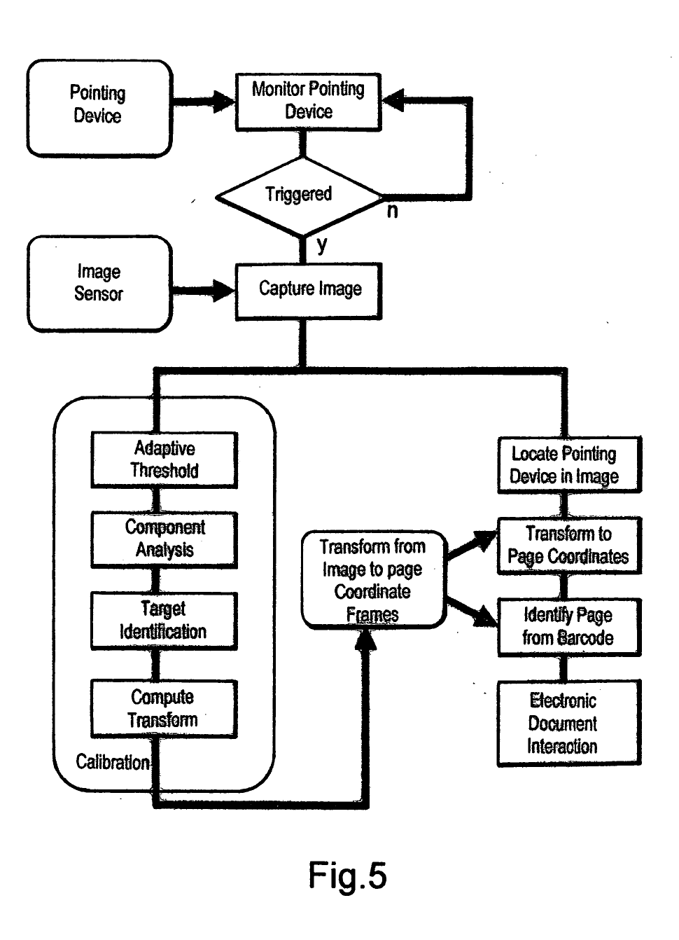

The flow chart of FIG. 5 shows a sequence of actions that are suitably carried out in using the system and which is initiated by triggering a switch associated with a pointing device 9 for pointing at the document 1 with the field of view of the camera 2 image sensor. The triggering causes capture of an image from the camera 2, which is then processed by the computer 4

As noted above, in the example of FIG. 1 the apparatus comprises a tethered pointer 9 with a pressure sensor at its tip that may be used to trigger capture of an image by the camera 2 when the document 1 is tapped with the pointer tip 9. This image is used for calibration to calculate the mapping from image to page co-ordinates; for page identification from the barcodes; and to identify the current location of the end of the pointer 9.

The calibration and page identification operations are best performed in advance of mapping any pointing movements in order to reduce system delay.

The easiest way to identify the tip of the pointer would be to use a readily differentiated locatable and identifiable special marker at the tip. However, other automatic methods for recognising long pointed objects could be made to work. Indeed, pointing may be done using the operator's finger provided that the system is adapted to recognise it and respond to a signal such as tapping or other distinctive movement of the finger or operation of a separate switch to trigger image capture.

The recognition of a pointing gesture made with either the hand or a pointing implement such as a pen or pencil, including a gesture to use, involves firstly the pointer entering the field of the camera. Background subtraction (fixed camera) can detect the moving pointer. After this, the pointer will stop while the position on the page is indicated. The pointer will either be a hand or pen so detecting the flesh colour of the hand is a useful technique; the pointer will be projecting from the main body of the hand and will move with the hand.

Determining the pixels of the hand can be done by separating skin coloured hand pixels from a known background or by exploiting the motion of the hand. This may be done using a Gaussian Mixture Model (GMM) to model the colour distribution of the hand region and the background regions, and then, for each pixel, calculating the log likelihood ratio:

$$Target function , f ( x ) = log ( \frac{p ( x \vert {ω}_{1}}{x \vert {ω}_{2}} )$$

where x represents position and ? represents colour.

Determining the general orientation of the hand can be done by calculating the principal axes of the hand, and then calculating the centroid or first mean and using it as the first control point. Next the hand pixels are divided into two parts either side of the mean along the principal axis. Those pixels orientated closest to the centre of camera image are chosen. The mean of these “rightmost” pixels is then recalculated. These pixels are in turn partitioned into two parts either side of the new mean along the original principal direction of the hand pixels. The process is repeated a few times, each newly computed mean being considered a control point.

Determination of the orientation of the hand can then be done by finding the angle between the line from the 1st mean to the last mean, and the original principal direction.

A pointing gesture can easily be distinguished by recognizing a low standard deviation of the 4th mean, corresponding to a finger. The pointing orientation can be determined by finding the angle between the 1st mean and the last mean.

Information on recognising pointing gestures may also be found at:

C. Wren, A. Azarbayejani, T. Darrell, and A. Pentland, Pfinder: Real-time tracking of the human body. In Photonics East, SPIE, volume 2615, 1995. Bellingham, Wash. http//citeseer.nj.nec.com/wren97pfinder.html

More sophisticated approaches to learning hand gestures are disclosed in:

Wilson & Bobick “Parametric hidden markov models for gesture recognition”

IEEE transactions on pattern analysis and machine intelligence, vol 21, no. 9, September 1999.

Further useful information is in:

Y. Wu and T. S. Huang. View-independent recognition of hand postures. In CVPR, volume 2, pages 88-94, 2000. http://citeseer.nj.nec.com/400733.html

The present problem involves a camera looking down on the hand gesture below. Harder problems of interpreting sign language from harder camera view-points have been tackled. Simpler versions of the same techniques could be used for the present requirements:

T. Starner and A. Pentland. Visual recognition of American sign language using hidden markov models. In International Workshop on Automatic Face and Gesture Recognition, pages 189-194, 1995. http://citeseer.nj.nec.com/starner95visual.html

T. Starner, J. Weaver, and A. Pentland. Real-time American Sign Language recognition using desk and wearable computer-based video. IEEE Trans.Patt.Analy. and Mach. Intell., to appear 1998.http:/citeseer.nj.nec.com/starner98realtime.html

Some approaches using motion are disclosed in:

M. Yang and N. Ahuja. Recognizing hand gesture using motion trajectories. In CVPR 2000, volume 1, pages 466-472, http://citeseer.nj.nec.com/yang00recognizing.html and pointing gestures of the whole body are disclosed in:

R. Kahn, M. Swain, P. Prokopowicz, and R. Firby. Gesture recognition using the Perseus architecture. In Proceedings of the IEEE Conference on Computer Vision and Pattern Recognition, pages 734-74, 1996. http://citeseer.nj.nec.com/kahn96gesture.html.

Instead of using printed registration marks to identify the boundary of the page of paper, provided the page can be distinguished from the background, and that the page of paper the note is written on is rectangular (for example the background could be set to black), it is possible to use standard image segmentation techniques to identify the page boundary. Once the boundary of the pages is determined, a quadrilateral will have been determined—the corners of the quadrilateral can be used to define four correspondence points with a normalized image of the page. These four correspondence points can be used to define a perspective transform (as indicated above) which can be used to warp and re-sample the image to obtain a normalized image of the paper (i.e. as viewed straight down).

The task is simplified if it can be assumed that the camera has an un-occluded view of the note paper. However, it is necessary to obtain a normalized view of the note paper whilst a person is writing on it. An initial registration of the note paper's boundary could be made, and the outline then tracked as it moves.

Examples of standard image processing techniques to determine the boundary of the page include the:

Hough Transform—the Hough transform can be used to detect the occurrence of straight lines within an image. A page viewed under a camera is transformed by a perspective transformation from a rectangle into a quadrilateral. So the page boundary would be formed by the intersection of four distinct lines in the image. Hence the importance of defining a distinct background to produce a high contrast between the paper and the background.

Snakes—more sophisticated techniques than the Hough transform might be used to find the boundary of the paper. A form of a Snake is an active contour model that would use an energy minimization process to contract down onto or expand to the page boundary from an initial position (such as the outside of the image for contraction and the smallest enclosing rectangle within the background area for a balloon-like expansion). These techniques are developed for more complex contours than the page boundaries here and so they would need to be adapted for these simpler requirements.

In this context, we refer to:

M. Kass, A. Witkin, and D. Terzopoulos Snakes: Active Contour Models, Proc. lst Int. Conf. On Computer Vision, 1987, pp. 259-268.

V Caselles, R. Kimmel, and G. Sapiro. Geodesic active contours. In Fifth International Conference on Computer Vision, Boston, Mass., 1995. http://citeseer.nj.nec.com/caselles95geodesic.html

T F Cootes, A. Hill, C. J. Taylor, and J. Haslam. The use of active shape models for locating structures in medical images. In Proceedings of the 13^{th} International Conference on Information Processing in Medical Imaging, Flagstaff Ariz., June 1993. Springer-Verlag. http//citeseer.nj.nec.com/cootes94use.html

References to techniques for tracking a contour that could be made robust to occlusions of the hand is made in: A Blake and M. Isard. Active Contours. Springer-Verlag, 1998. These techniques are developed for more general contours and must be specialized for our significantly simpler requirements.

In this description, the term “data set” is intended to include any information content perceivable by a person through his senses, such as textural, pictorial, audio and video material. It may for example be the content of a web page on the Internet.

The term “note” is intended to mean any hand-written or printed material whether in the form of writing or symbols or other gestures, or printed label placed manually on a page, and it may occupy a small part of a page or the entire page or several pages. It may be created electronically on a note pad, but more preferably it is created on paper or some other two-dimensional permanent storage medium, since this is the easiest to use intuitively. The note could even be a code such as a barcode. The paper document may be of the form described above with reference to FIGS. 2 to 4, but it is not essential for the pages to have registration marks or identification marks printed on them, for example, programs are readily available for determining the orientation of pages by detecting the edges or corners, and also for compensating for distortions in the imaging system. The key point is that a logical spatial map of the page of notes is built up incrementally as note-taking proceeds, as will be described.

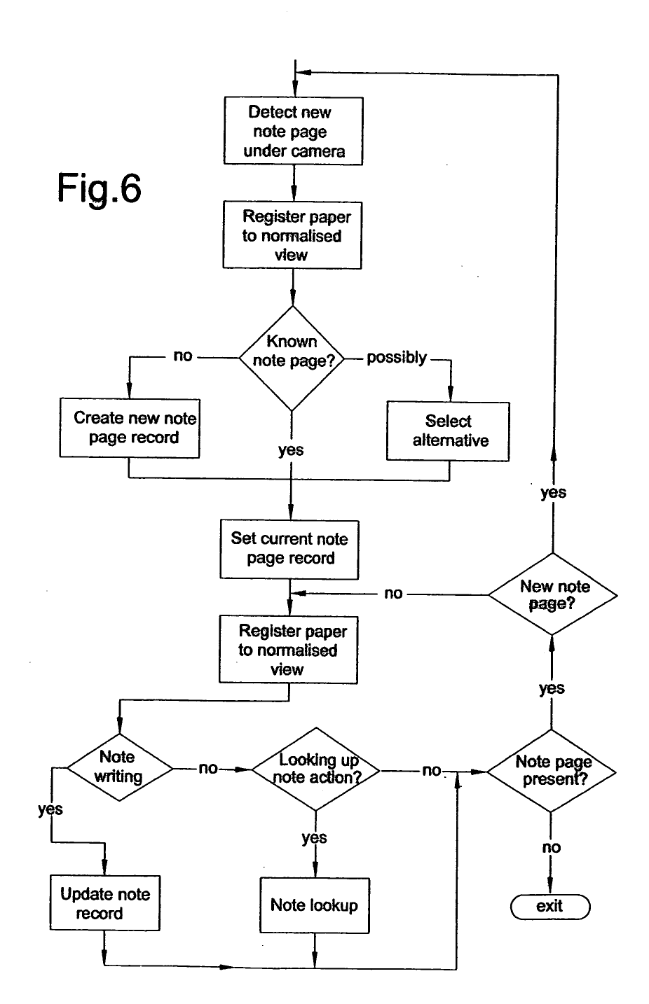

A computer system embodying the invention will now be described with reference to FIGS. 6 to 8. A personal computer (PC) or other appropriate processor is used to access the world-wide web using a web browser, and this is connected to a graphical input device such as that described above with reference to FIGS. 1 to 5. The image processing described by way of example with reference to FIG. 5 may be undertaken by the PC, or by a processor integrated with the camera. Further, the software for handling the notes and associating them with the content of the web pages, which is illustrated in FIGS. 6 to 8, may be incorporated in the PC or in the dedicated integrated processor. Alternatively, the use of a PC may be avoided by integrating the web browser with the other software, together with or separately from the camera.

The user browses the web in a conventional manner, and makes contemporaneous notes in handwriting using a pen or other stylus on notepaper presented to the camera. In this example, this is done on separate sheets of notepaper, so that the system is arranged to recognise discrete pages of notes. Each page is separately identifiable by its content, whether that is the notes itself or some registration marks.

The system first detects a new note page being placed under the camera (top of FIG. 6). In the step “register paper to normalised view”, the system recognises the orientation of the page and optimises the view in the camera. The system may register the page of notes with an ideal view of the page of notes, using tags or through the use of image processing. Pure image processing may be used to determine page boundary, and then to register the quadrilateral with a normalised view of the page (as described above). By scanning and processing the image of a page the system can determine whether the note page has previously been recorded, by comparing it by a correlation process (using tags or image processing) with previously-recorded pages of notes.

To decide whether the note placed under the camera has been seen before, the image of the page must be compared with the previous notes placed under the camera.

Assuming that normalized views of all the pages of notes have been obtained simplifies the problem significantly. There are many notions of image similarity that could be used but they are usually chosen to be invariant to geometric transformations such as rotation, translation and scaling. Clearly these techniques could still be used and there are a wide range of image processing techniques that could be used to address this problem.

Cross-correlation as an image similarity measure is perhaps the simplest approach:

$$r ( d ) = \frac{{\sum }_{i} [ ( x ( i ) - mx ) * ( y ( i - d ) - my ) ]}{\sqrt{{\sum }_{i} {( x ( i ) - mx )}^{2}} \sqrt{{\sum }_{i} {( y ( i - d ) - my )}^{2}}}$$

where x,y are two normalized images, and mx, my are their means;

the delay (d) for comparing the two images will be zero. The cross-correlation could be computed in the intensity space or in the colour space but would have to be slightly adapted for vector analysis; see:

R. Brunelli and T. Poggio. Template matching: matched spatial filters and beyond. Pattern Recognition, 30(5):751-768, 1997. http://citeseer.nj.nec.com/brunelli95template. html

http://astronomy.swin.edu.au/pbourke/analysis/correlate/index.html

More sophisticated approaches that examine the layout or spatial structure of the page could be used:

Text Retrieval from Document Images based on N-Gram Algorithm Chew Lim Tan, Sam Yuan Sung, Zhaohui Yu, and Yi Xu School of Computing . . .

### PRICAI Workshop on Text and Web Mining

Jianying Hu, Ramanujan Kahi, and Gordon Wilfong, 1999. Document image layout comparison and classification. In Proc. Of the Intl. Conf. on Document Analysis and Recognition

H. S. Baird, Background Structure in Document Images, in H. Bunke (Ed.), Advances in Structural and Syntactic Pattern Recognition, World Scientific, Singapore, 1992, pp. 253-269. http://citeseer.nj.nec.com/baird92background.htm

Simpler colour and texture based similarity measures could be used:

Anil K. Jain and Aditya Vaitya. Image retrieval using colour and shape. Pattern Recognition, 29(8): 1233-1244, August 1996. http://citeseer.nj.nec.com/jain96image.html

John R. Smith and Shih-Fu Chang. Visualseek: a fully automated content-based image query system. In Proceedings of ACM Multimedia 96, pages 87-98, Boston Mass. USA, 1996. http://citeseer.nj.nec.com/smith96visualseek.html

N. Howe. Percentile blobs for image similarity. In Proceedings of the IEEE Workshop on Content-Based Access of Image and Video Libraries, pages 78-83, Santa Barbara, Calif., June 1998. IEEE Computer Society.

If the note page is a known note page, then the system in FIG. 6 proceeds to the next step: “set current note page record” which temporarily identifies the imaged note page as the current note page. If there is some doubt that the page has previously been recorded, then the user optionally interacts at this point, and selects from a drop down list of alternatives. If no previously-recorded note page can be identified, then a new note page record is created, and this is set as the current note page.

The step of registering the paper is repeated, and the next stage depends on whether the user has indicated that he intends to write a note, or whether he is using the existing page of notes to retrieve a corresponding data set. The answer to this question is determined by a user input, such as the fact that a pen is presented to the camera, or the fact that a stylus is depressed to click a switch.

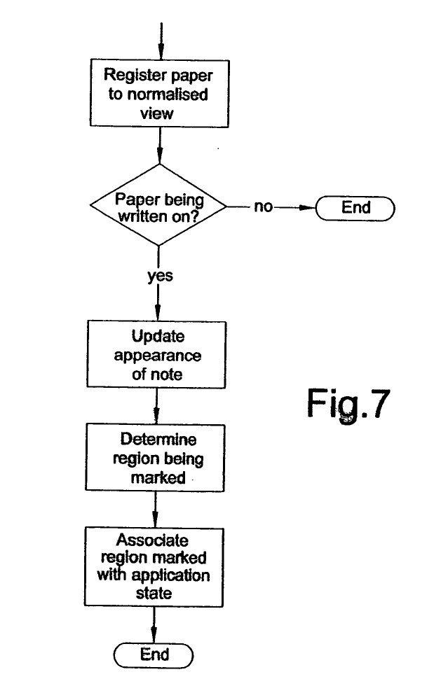

In the case of note writing, the page is annotated manually with a new note, in the step “update note record” shown in greater detail in FIG. 7.

In the routine shown in FIG. 7 entitled “update note record”, the step of registering the paper to the ideal view is repeated, and the system then determines whether the paper is being written on. If not, then the routine is ended. If however the paper is being written on, then the appearance of the note is updated as the note is made manually, the region being marked on the page is determined, and the marked region is then associated with the state of the application running in the data processor, which in this example would include the fact that the web browser is browsing the current URL. The routine then ends. In this way, each marked region on the page is associated with a corresponding web page, which was being viewed at the time the note was taken.

In this way, the processor creates a logical spatial map of the page, with a plurality of different marked regions whose positions are known. The map is built on incrementally. Anything that occupies a spatial location on the page can be part of the map.

Returning to the flowchart of FIG. 6, if the system determines that it is not in the note writing mode, then it checks that it is in the mode for looking up note actions, i.e. for using existing notes to index data sets. If the answer to this is no, then the system checks that a note page is present under the camera, and exits if not, but then waits for a new page. As it is waiting for the new page, it loops to ensure adequate registration of the paper if this had been the reason for it wrongly assuming that no note page was present. Once a new page is entered, then the system returns to the top of FIG. 6 to initiate the process by detecting a new note under the camera.

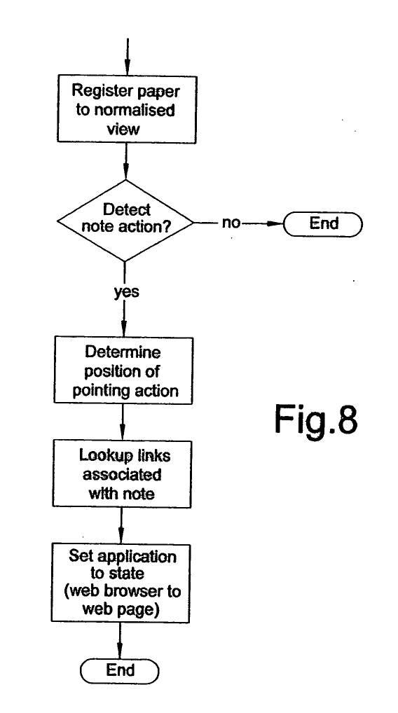

Assuming that the system is in the mode for looking up note action, i.e. indexing a data set, then it enters the “note look up” routine of FIG. 8.

In FIG. 8, the process of registering the paper for a normalised view is repeated, and the system then checks that it has detected a “note action”, i.e. a current note record is set. If not, the routine is ended. If so, the system determines the position of the pointing action under the camera, enabling the user to gesture using the pen or other pointing device. This gesture indicates which of several possible notes is intended by the user to be taken as the index to the data set. The system then uses the relevant note record to access its memory of links associated with that note. For example, it would identify the URL of the website, and the particular web page, associated with that note being pointed at. The system then sets the application running in the data processor to the state it was in when the note was taken. For example, it sets the web browser to read the specific web page concerned. The routine then ends.

If the web page address being examined cannot be obtained with the co-operation of the web browser, then it must of course be obtained by indirect means.

The signalling of a new page of notes with no prior associations linking them to states of the data processor is done by placing the new page under the camera, creating new note records, and then associating the region of the note with the application state, such as the URL. This might be done using a mouse or keyboard, or a gesture, or through the use of special paper in the form of a talisman, with a unique identification mechanism.

It will be appreciated that when the hand-written note is captured it will occupy particular parts of the page, and this spatial area will be associated with the current web page. This determination of the region being marked has to cope with movement of the page, and occlusion of the paper by the hand. Occlusion of the paper can be eliminated by forming two separate images from different angles, and bringing them to register, so as to separate out the images of the hand and the pen.

The identification of pages of previous notes from the camera image needs to cope with different lighting conditions, and the different states of the paper which may be folded or crumpled and may be at any arbitrary orientation.

The selection of the part of the paper, when looking up existing notes to dictate the accessing of corresponding data sets, involves gesturing over the paper, and the use of special pens and buttons can ease this task, but it is also plausible to simply use hand and pen tracking of gestures through the camera.

The system may optionally also be used for retrieving some or all of the hand-written notes which have been associated, either by the present user or by other users, for example, with a particular data set, such as one page of a website. Clearly some form of security would need to be used to control access to the notes recorded by other users.

To achieve this retrieval of notes, the data processor is set to the state corresponding to a particular web page, for example, and the user then inputs a requirement for one or more notes associated with that application state. The associated hand-written note or notes are then displayed on the screen, for example as an overlay image over the web page, or they may be printed onto paper or another medium, with sufficiently fine resolution to make the notes readable. This lends itself to the re-use of notes which might previously have been forgotten for example in the search of a holiday or a particular product by web browsing. The re-used notes may be associated with new application states.

An embodiment of the third and fourth inventions uses audio speech instead of notes, but still linked by the processor to the current state of the data processor whilst accessing a particular data set. The computer system has an audio input device comprising a microphone and amplifier and a digital or analogue recording medium, capable of recording strings of input speech from a user. The system also has data storage linking each stored audio speech recording with the corresponding state of the data processor, e.g. the state in which its web browser is viewing a page at a specific URL. In this way, the user annotates the content of the web page with his own commentary on it. The system subsequently allows all, or selected ones of, such audio speech recordings to be retrieved for reproduction through an audio amplifier and speaker, when the data processor is accessing the same web page or other data set. Preferably also the system comprises a speech recognition processor which is capable of interpreting input speech and comparing it with the audio speech recordings in order to find a match or the best match. In this way, the system may then be instructed to assume the state it was in when it was accessing the data set associated with that matched recording. Thus, the user may retrieve the required data set by speaking part or all of the content of the associated speech recording. The system may be programmed to retrieve a list of candidate audio recordings and their associated web pages or other data sets. This is a new form of automated search for data which has previously been annotated.

The “audio speech” may include other types of audio expression such as singing and non-spoken sounds, and need not be human.

In other respects, the computer system is analogous in its operation to that of the first and second inventions which use notes. In more general terms, the invention may therefore be applied to all forms of recording whether as an annotation or a label, audio or graphic or otherwise, even to smells and colours and textures, which may be linked sensibly to the content of a data set, the link association being recorded by the computer system.

1. A method of accessing a stored data set using a data processor whose state determines which data set of many is accessed, comprising manually entering a note on a page using a graphical input device, the note relating to the content of the data set currently accessed by the data processor, identifying and storing the location of the note in a logical spatial map for the page, repeating the manual entry and storage steps to build up a plurality of such notes linked to the corresponding states of the processor, and then identifying in the spatial map the corresponding previously entered note, by retrieving a required data set by manually selecting the corresponding page in the graphical input device and gesturing on the page; resetting the data processor to its corresponding state by using the corresponding previously entered note identified in the spatial map and accessing thereby the corresponding data set linked to the note.

2. A method according to claim 1, in which the graphical input device comprises note paper and a writing and/or pointing implement and a camera focused on the note paper to read its content.

3. A method according to claim 2, in which the manual entry of the note comprises reading the page of note paper and identifying whether any note on it has previously been recorded electronically, recording that note electronically if it has not previously been recorded electronically, and updating a logical spatial map for that page with the note entered.

4. A method according to claim 2, in which the retrieval comprises presenting a page to the camera and reading and identifying a specific note on the page using a manual gesture on the note paper viewed and read by the camera.

5. A method of associating hand written notes with a stored data set, comprising using a data processor to access the data set, making meaningful hand-written notes, reading and storing images of those notes linked to a record of the state of the data processor when accessing the data set; repeating the process for multiple data sets; then retrieving and reproducing some or all of the associated notes linked with any data set currently being accessed by the data processor, by addressing the record with the current state of the data processor.

6. A method according to claim 5, in which the reproduction of the notes is in the form of an image displayed on a screen which also displays the data set.

7. A method according to claim 5, in which the reproduction of the notes is in the form of a printed image.

8. A method according to claim 1, in which the data set is on a web page on the world-wide web, and the data processor comprises a web browser.

9. A method according to claim 1, in which the data set is stored in an on-line data repository or bulletin board accessible by a navigation device or other appropriate program in the data processor.

10. A method according to claim 1, comprising identifying the page in the graphical input device from previously recorded pages.

11. A method according to claim 1, in which the data set is not linked temporally to the other data sets by any time-indexing system, but only by the sequence in which they are accessed.

12. A computer system for accessing a stored data set, comprising a data processor whose state determines which data set of many is accessed, connected to a graphical input device for the manual entry of a note on a page, the note relating to the content of the data set currently accessed by the data processor, and a processor for identifying and storing the location of the note in a logical spatial map for the page, repeating the manual entry and storage steps to build up a plurality of such notes linked to the corresponding states of the processor, and then retrieving a required data set by manually selecting the corresponding page in the graphical input device and gesturing on the page to identify in the spatial map the corresponding previously-entered note, using this to reset the data processor to its corresponding state and accessing thereby the corresponding data set linked to the note.

13. A memory storing a computer program for use in a system for accessing a stored data set, the program having the steps of controlling a graphical input device to read a note entered manually on a page, the note relating to the content of the data set currently accessed by the data processor, identifying and storing the location of the note in a logical spatial map for the page, repeating the manual entry and storage steps to build up a plurality of such notes linked to the corresponding states of the processor, and then retrieving the required data set by controlling the graphical input device to read a manually selected corresponding page and to read gestures made manually on the page to identify in the spatial map the corresponding previously-entered note, using this to reset the data processor to its corresponding state and accessing thereby the corresponding data set linked to the note.

14. A computer system for associating hand-written notes with a stored data set, comprising a data processor for accessing the data set, a reader and memory for reading and storing images of hand-written notes relevant to the data set, linked to a record of the state of the data processor when accessing the data set; and for then retrieving and reproducing some or all of the associated notes linked with any data set currently being accessed by the data processor, by addressing the record with the current state of the data processor.

15. A memory storing a computer program for use in a system for associating hand-written notes with a stored data set, the system having a data processor for accessing the data set, the program having the steps of reading and storing images of hand-written notes relevant to the data set, linked to a record of the state of the data processor when accessing the data set; repeating the process for multiple data sets; and then retrieving and reproducing some or all of the associated notes linked with any data set currently being accessed by the data processor, by addressing the record with the current state of the data processor.
